(19) United States
(12) Patent Application Publication
(10) Pub. No.: US 2010/0028617 A1
(43) Pub. Date: Feb. 4, 2010

(54) BAMBOO STRAND REINFORCED MEDIA AND BUILDING MATERIALS

(76) Inventor: Jay Plaehn, Cle Elum, WA (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/183,355

(22) Filed: Jul. 31, 2008

(51) Int. Cl. B32B 3/28; B32B 5/02; B05D 5/02; B05D 1/36

(52) U.S. Cl. 428/182; 428/98; 427/256; 427/261; 493/393

(57) ABSTRACT

A building, packing, or shipping material is provided. The building material includes at least one panel of sheet material and at least two strands of bamboo. The bamboo is capable of being affixed to the panel of sheet material such that the combination of the panel of sheet material and the at least two strands of bamboo is strong and capable of providing support to a structure. The combination of the panel of sheet material and bamboo can be layered with additional combinations of panels of sheet material and bamboo to create panels of varying thickness.

### FIELD OF INVENTION

The present invention relates generally to strong, lightweight, and inexpensive packing materials and more particularly to the use of bamboo in conjunction with corrugated cardboard or corrugated plastic to make cheaper building panels and stronger packing and shipping crates. Further, the present invention relates generally to sheets and panels of building materials used in conjunction with stucco or plaster to build homes and buildings and more particularly to the use of bamboo in conjunction with tar paper, building paper, or house wrap to build a structure to which stucco or plaster can adhere.

### BACKGROUND OF THE INVENTION

Traditionally, cardboard and/or plywood have been used for packing and shipping. However, often cardboard is not strong enough to support extremely heavy or large items. In this event and others, wood or plywood must be used to build packing and shipping crates.

Wood is generally cut from naturally grown trees. However, trees are limited in supply due to the length of time necessary for a tree to reach maturity. Additionally, the supply of natural wood is limited by the deforestation that is now occurring in many parts of the world. Accordingly, the price of wood has increased, and wood must be imported, especially in many parts of the world where there is not a large supply of wood.

There is thus a continuing, ongoing need for strong, lightweight, and inexpensive packing and shipping materials that are readily available or easily accessible in areas of the world in which lumber is in short supply. Preferably, such packing and shipping materials should provide superior strength to the packing and shipping crates in which they are used.

In areas of the world where the supply of wood and lumber is scarce, stucco and plaster are often used on homes, shelters, and buildings as an economical alternative to expensive wood structures. The use of stucco is especially prevalent in warm and temperate climates because it helps to keep homes cool.

Before stucco is applied to a structure, traditionally tar paper is first affixed to the frame of the structure and a wire mesh is affixed on top of the tar paper. Alternatively, a building paper and wire mesh combination can be purchased as a one-step application material. Tar paper, building paper, or house wrap is vapor-permeable and water-resistant to protect the interior of the structure from outside moisture without trapping water inside of the walls. The wire mesh is used to give the stucco something to attach to, to add strength to the stucco, and to prevent the stucco from cracking.

However, the one-step application material of building paper and wire mesh is not readily available in some parts of the world. Specifically, in many areas of the world where stucco is an ideal option for building homes because of its cooling properties and resistance to the elements of a desert or tropical environment, wire mesh and tar paper, building paper, or house wrap must be imported. This importation of materials can be a time-consuming and expensive endeavor.

There is thus an additional continuing and ongoing need for building materials to be used in conjunction with stucco that are readily available or easily accessible in areas of the world in which stucco is an ideal building material. Preferably, such building materials should provide superior strength to the homes in which they are used. Further, the layering of multiple sheets of such building materials should provide panels that can be used as walls in regions where resources are scarce for building economical and temperate structures.

### SUMMARY OF THE INVENTION

Accordingly, it is a benefit of the present invention to provide alternative packing and shipping materials that limit the use of wood and plywood and are at the same time strong, light, and free from insects and parasites such that the materials meet the international shipping standards and certification rules.

It is a further benefit of the present invention to provide packing and shipping materials that are readily available or easily accessible in areas of the world in which wood is expensive and in short supply.

It is another benefit of the present invention to provide packing and shipping materials that provide superior strength to the packing and shipping crates in which they are used.

It is yet another benefit of the present invention to provide packing and shipping materials that are lightweight when incorporated into a packing and shipping crate.

It is still a further benefit of the present invention to provide building materials that can be used in connection with stucco and plaster.

It is another benefit of the present invention to provide building materials that are readily available or easily accessible in areas of the world in which stucco and plaster are ideal building materials.

It is yet another benefit of the present invention to provide building materials that provide superior strength to the structures in which they are used.

Finally, it is a benefit of the present invention to provide building materials that can be layered to varying thicknesses to create building panels for walls in home and building construction.

In accordance with the present invention, all of these benefits as well as others not herein specifically identified, are generally achieved by the present bamboo strand reinforced media and building materials.

### BRIEF DESCRIPTION OF THE DRAWINGS

Various examples of objects, features and attendant advantages of the present invention will become fully appreciated as the same becomes better understood when considered in conjunction with the accompanying drawings, wherein:

FIG. 1 illustrates a panel of corrugated cardboard, corrugated plastic, or sheet material in accordance with the present invention;

FIG. 2 illustrates a panel of corrugated cardboard, corrugated plastic, or sheet material in accordance with the present invention having bamboo strands affixed thereto in a parallel manner; and

FIG. 3 illustrates a panel of corrugated cardboard, corrugated plastic, or sheet material in accordance with the present invention having bamboo strands affixed thereto in a criss-cross manner.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include packing materials that use bamboo in conjunction with corrugated cardboard or corrugated plastic. The combination of bamboo and corrugated cardboard or plastic can be used to make packing and shipping crates that use the natural tensile strength of the bamboo for added strength to the crate.

The use of corrugated cardboard or plastic in lieu of traditional wood or plywood used to make packing or shipping crates provides for a lightweight structure. Additionally, the use of the bamboo in conjunction with the corrugated cardboard or plastic provides for increased strength to the cardboard or plastic.

The cardboard or corrugated plastic can be water and weather-proofed as necessary. In embodiments of the claimed invention, the cardboard can be treated with wax.

Bamboo, in the form of strands or slats, can be affixed to the corrugated cardboard or plastic as would be understood by one of ordinary skill in the art. Bamboo strands can be made from bamboo stalks. The bamboo stalks can be further split using a star splitter, as would be understood by one of ordinary skill in the art, to form the bamboo strands. The bamboo strands can be manufactured into slats.

It is to be understood that the dimensions of the bamboo strands or slats are not limitations of the present invention. Rather, the bamboo has dimensions such that it is easy to work with, retains its superior tensile strength, and provides strength to the structure of which it is a part.

The bamboo can be affixed to a panel or sheet of corrugated cardboard or plastic in a parallel manner. Alternatively, the bamboo can be affixed to a panel or sheet of corrugated cardboard or plastic in a criss-cross manner. The bamboo can use its own tensile strength to provide strength and rigidity to the corrugated cardboard or plastic.

The bamboo strand reinforced corrugated cardboard or plastic can be of varying thickness. In this vein, multiple pieces of bamboo strand reinforced corrugated cardboard or plastic can be adhered together to form layers, similar to the way layers of wood form plywood.

The bamboo strand reinforced corrugated cardboard or plastic, or layers of the bamboo strand reinforced corrugated cardboard or plastic can be manufactured or cut into panels. It is to be understood that the dimensions of these panels are not limitations of the present invention. Rather, the panels have dimensions such that they are easy to work with and manufacture into a packing or shipping crate or to be used as walls in home building. In embodiments of the present invention, the sheet material panels can be 3 feet by 8 feet for use in home building, for example, to be used in conjunction with stucco, and 4 feet by 8 feet for use with standardized packing or shipping crates.

The bamboo situated between layers of corrugated cardboard or plastic can be combined with an insulating filler as described and disclosed in U.S. application Ser. No. 12/042,723, which is hereby incorporated by reference.

Further embodiments of the present invention include building materials that use bamboo in conjunction with stucco. Sheet material, such as tar paper, building paper, or house wrap, can be used as would be understood by those of skill in the art. Specifically, a panel of sheet material can be affixed to the frame of a structure. In alternate embodiments, cardboard or corrugated plastic, for example, can be used as sheet material in lieu of tar paper, building paper, or house wrap. The cardboard or corrugated plastic can be water and weather-proofed as necessary. In embodiments of the claimed invention, the cardboard can be treated with wax.

The sheet material can be manufactured or cut into panels. It is to be understood that the dimensions of these panels are not limitations of the present invention. Rather, the sheet material panels have dimensions such that they are easy to work with, affix to a frame of a structure, and ship to a building site. In embodiments of the present invention, the sheet material panels can be, for example 3 feet 8 feet, or 4 feet by 8 feet, or 10 feet by 40 feet and can be of varying thickness in single or multiple layers.

Bamboo, in the form of strands or slats, can be affixed to the sheet material in lieu of traditional wire mesh. Bamboo strands can be made from bamboo stalks. The bamboo stalks can be split using a star splitter, as would be understood by one of ordinary skill in the art, to form the bamboo strands. The bamboo strands can be further manufactured into slats.

It is to be understood that the dimensions of the bamboo strands or slats are not limitations of the present invention. Rather, the bamboo has dimensions such that it is easy to work with, retains its superior tensile strength, and facilitates stucco adhering thereto.

The bamboo can be affixed to a panel of sheet material in a parallel manner. Alternatively, the bamboo can be affixed to a panel of sheet material in a criss-cross manner. The bamboo can use its own tensile strength to provide strength and rigidity to the panel of sheet material.

A panel or panels of sheet material can be affixed to the inside or outside of a frame of a structure or both. The bamboo can be affixed to the sheet material. Stucco or plaster can be applied to the bamboo and sheet material combination, and the bamboo can facilitate the stucco or plaster adhering thereto. Further, the bamboo can use its own tensile strength to provide strength and rigidity to the sheet material.

Panels of sheet material with bamboo affixed thereto can be adhered together to form layers. When panels of multiple layers are stacked together the resulting panel can be, for example, anywhere from 0.5 to 8 inches thick. The thickness of the resulting panel will be determined by how many panels are stacked together. Such multi-layer panels more fully utilize the natural tensile strength of the bamboo strands.

In embodiments of the present invention, the bamboo strands can be textured. The texture on the strands can provide for an even greater ability to adhere to the stucco applied thereto. Furthermore, the textured bamboo can increase the bond between the bamboo and the stucco

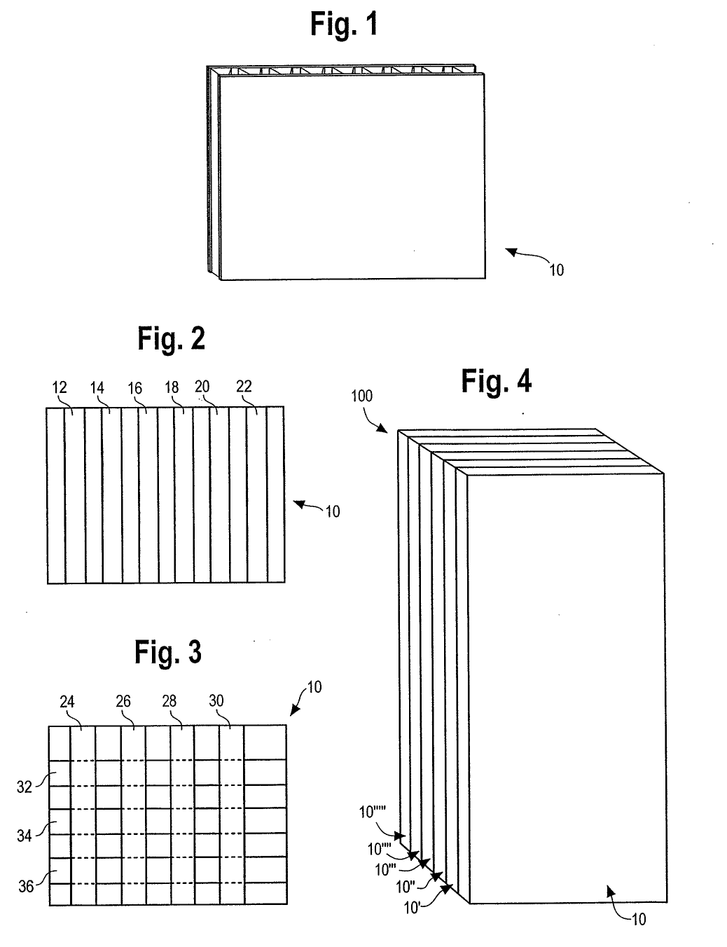

FIG. 1 illustrates a panel of corrugated cardboard, corrugated plastic, or sheet material 10 in accordance with the present invention. Sheet material in accordance with the present invention can be, for example, tar paper, building paper, or house wrap. In embodiments of the claimed invention, the panel 10 can be affixed to a frame of a structure using means as would be understood by those of ordinary skill in the art. For example, the panel of sheet material 10 can be affixed to a structure using nails.

FIG. 2 illustrates a panel 10 in accordance with the present invention having bamboo strands 12, 14, 16, 18, 20, and 22 affixed thereto in a parallel manner. The bamboo strands 12, 14, 16, 18, 20, and 22 can use their own tensile strength to provide strength and rigidity to the panel 10.

In embodiments of the claimed invention in which the panel is affixed to the frame of a structure, stucco applied to the bamboo strands 12, 14, 16, 18, 20, and 22 can adhere to the bamboo strands 12, 14, 16, 18, 20, and 22.

It is to be understood that the number of bamboo strands affixed to a panel and the spacing therebetween are not limitations of the present invention. Rather, the number of bamboo strands affixed to a particular panel should be such that the combination of the panel and bamboo retains the superior strength of the bamboo strands. In embodiments in which the panel is affixed to the frame of a structure, the number of bamboo strands affixed to a particular panel should be such that stucco applied to the combination of the bamboo and panel can sufficiently adhere to the bamboo strands.

FIG. 3 illustrates a panel of corrugated cardboard, corrugated plastic, or sheet material 10 in accordance with the present invention having bamboo strands 24, 26, 28, 30, 32, 34, and 36 affixed thereto in a criss-cross manner. The criss-cross pattern of the bamboo provides for even greater strength and rigidity of the panel.

In embodiments of the claimed invention where the panel is affixed to the frame of a structure, stucco applied to the combination of the panel and criss-corssed bamboo can adhere to the criss-cross pattern with an even greater degree of adhesion.

In alternate embodiments, a second panel of corrugated cardboard or plastic or sheet material can be affixed to the bamboo, which is affixed to the first panel 10. A second set of bamboo can be further affixed to the second panel, a third panel can be affixed to the second set of bamboo, and so forth. In this manner, pieces of material can be created of varying thickness. Referring to FIG. 4, a panel 10 is shown wherein the panel is affixed to a second panel 10′, the second panel 10′ is affixed to a third panel 10″, the third panel 10″ is affixed to a fourth panel 10′″, the fourth panel 10′″ is affixed to a fifth panel 10″″, and the fifth panel 10″″ is affixed to a sixth panel 10′″″. Each panel 10, 10′, 10″, 10′″, 10″″, 10′″″, as see in FIG. 4 can be affixed to bamboo as previously described. The resulting panel 100 can be used to create building panel walls and packing or shipping crates.

From the foregoing, it will be observed that numerous variations and modifications may be effected without departing from the spirit and scope of the invention. It is to be understood that no limitation with respect to the specific apparatus or method illustrated herein is intended or should be inferred. It is, of course, intended to cover by the appended claims all such modifications as fall within the scope of the claims.

What is claimed is:

1. A building, packing, or shipping material comprising:
at least one panel of sheet material; and
at least two strands of bamboo wherein the strands of bamboo are capable of being affixed to the panel of sheet material such that the combination of the panel of sheet material and the at least two strands of bamboo is strong and capable of providing support to a structure.

2. A building, packing, or shipping material as in claim 1 wherein the panel of sheet material is one of tar paper, building paper, or house wrap.

3. A building, packing, or shipping material as in claim 1 wherein the panel of sheet material is cardboard.

4. A building, packing, or shipping material as in claim 3 wherein the panel of sheet material is coated with wax.

5. A building, packing, or shipping material as in claim 1 wherein the panel of sheet material is corrugated plastic.

6. A building, packing, or shipping material as in claim 1 wherein the panel of sheet material is water proofed.

7. A building, packing, or shipping material as in claim 1 wherein the at least two strands of bamboo are situated in a parallel pattern relative to one another.

8. A building, packing, or shipping material as in claim 1 wherein the at least two strands of bamboo are situated in a criss-cross pattern relative to one another.

9. A building, packing, or shipping material as in claim 1 wherein at least one of the strands is textured.

10. A building, packing, or shipping material as in claim 1 wherein the material uses a tensile strength of the at least two strands of bamboo to provide strength to the panel of sheet material.

11. A building, packing, or shipping material as in claim 1 wherein the at least two strands of bamboo can be combined with an insulating filler.

12. A building, packing, or shipping material as in claim 1 wherein at least a second panel of sheet material is capable of being affixed to the at least two strands of bamboo affixed to the at least one panel of sheet material.

13. A method of applying stucco to a structure comprising:
affixing at least one panel of sheet material to the structure;
affixing at least two strands of bamboo to the at least one panel of sheet material; and
applying the stucco to the at least two strands of bamboo affixed to the at least one panel of sheet material wherein the at least two strands of bamboo provide strength to the at least one panel of sheet material, and the at least two strands of bamboo facilitate the stucco adhering thereto.

14. A method as in claim 13 wherein the at least one panel of sheet material is one of tar paper, building paper, or house wrap.

15. A method as in claim 13 wherein the at least one panel of sheet material is cardboard.

16. A method as in claim 15 further comprising coating the at least one panel of sheet material with wax.

17. A method as in claim 13 wherein the at least one panel of sheet material is corrugated plastic.

18. A method as in claim 13 further comprising water proofing the at least one panel of sheet material.

19. A method as in claim 13 wherein the at least two strands of bamboo are affixed to the at least one panel of sheet material in a parallel pattern relative to one another.

20. A method as in claim 13 wherein the at least two strands of bamboo are affixed to the at least one panel of sheet material in a criss-cross pattern relative to one another.

21. A method as in claim 12 further comprising applying an insulating foam to the at least two strands of bamboo before applying the stucco.

22. A method of manufacturing a building, packing, or shipping material comprising:
sizing a panel of sheet material to a desired size; and
affixing a first set of at least two strands of bamboo to the at least one panel of sheet material wherein the at least two strands of bamboo provide strength to the at least one panel of sheet material.

23. A method as in claim 22 further comprising affixing a second panel of sheet material to the at least two strands of bamboo.

24. A method as in claim 23 further comprising affixing a second set of at least two strands of bamboo to the second panel of sheet material.

25. A method as in claim 22 wherein the at least one panel of sheet material is one of tar paper, building paper, or house wrap.

26. A method as in claim 22 wherein the at least one panel of sheet material is cardboard.

27. A method as in claim 26 further comprising coating the at least one panel of sheet material with wax.

28. A method as in claim 22 where in the at least one panel of sheet material is corrugated plastic.

29. A method as in claim 22 further comprising water proofing the at least one panel of sheet material.

30. A method as in claims 22 wherein the first set of at least two strands of bamboo are affixed to the at least one panel of sheet material in a parallel pattern relative to one another.

31. A method as in claim 22 wherein the first set of at least two strands of bamboo are affixed to the at least one panel of sheet material in a criss-cross pattern relative to one another.

32. A method as in claim 22 further comprising applying an insulating form to the first set of at least two strands of bamboo.
